(19) United States
(12) Patent Application Publication
(10) Pub. No.: US 2026/0191709 A1
(43) Pub. Date: Jul. 9, 2026

(54) VEHICLE SEAT AND CONTROL METHOD FOR THE SAME

(71) Applicants: Hyundai Motor Company, Seoul (KR); Kia Corporation, Seoul (KR); Hyundai Transys Inc., Seosan-si (KR)

(72) Inventors: Eun Sue KIM, Hwaseong-si (KR); Sang Hark LEE, Hwaseong-si (KR); Ji Yun HA, Hwaseong-si (KR); Soo Bok KIM, Hwaseong-si (KR); Jun Hyung KWON, Hwaseong-si (KR); Duk Kyu BYUN, Hwaseong-si (KR); Sin Jeong KANG, Hwaseong-si (KR); Seong Bin JEONG, Hwaseong-si (KR)

(73) Assignees: Hyundai Motor Company, Seoul (KR); Kia Corporation, Seoul (KR); Hyundai Transys Inc., Seosan-si (KR)

(21) Appl. No.: 19/289,919

(22) Filed: Aug. 4, 2025

(30) Foreign Application Priority Data
Jan. 9, 2025 (KR) 10-2025-0003696

(51) Int. Cl. A61G 5/14; B60N 2/00; B60N 2/02; B60N 2/12

(52) U.S. Cl. CPC A61G 5/14; B60N 2/0025; B60N 2/12; B60N 2002/0216; B60N 2210/40

(57) ABSTRACT

Disclosed are a vehicle seat and a control method thereof, which induce the forward seating of a seated person and assist the standing of the seated person by controlling a tip-up actuating assembly, a tilting actuating assembly, and a support plate based on the distribution of body pressure acting on a seat cushion.

### CROSS-REFERENCE TO RELATED APPLICATION(S)

The present application claims priority to Korean Patent Application No. 10-2025-0003696, filed on Jan. 9, 2025, the entire contents of which is incorporated herein for all purposes by this reference.

### BACKGROUND OF THE DISCLOSURE

### Field of the Disclosure

The present disclosure relates to a vehicle seat and a control method thereof, which induce the forward seating of a seated person and assist the standing of the seated person by controlling a tip-up actuating assembly, a tilting actuating assembly, and a support plate based on the distribution of body pressure acting on a seat cushion.

### Description of the Prior Art

A vehicle seat allows an occupant to sit comfortably in the vehicle and use the vehicle.

When an elderly person with weak leg strength or a passenger with a lower limb disability boards a vehicle, a structure in which the seat moves out of the vehicle to accommodate the elderly person or the passenger has been widely used. However, this method requires a mechanism such as a robot to move the seat, which results in drawbacks such as increased weight and material costs.

Accordingly, there is a demand for a vehicle seat and a control method thereof that enhance the convenience of getting on and off by assisting the movements of an elderly person with weak leg strength or a passenger with a lower limb disability while reducing weight and material costs.

The foregoing described as the background art is intended merely to aid in the understanding of the background of the present disclosure, and is not intended to mean that the present disclosure falls within the purview of the related art already known to those skilled in the art.

### SUMMARY

The present disclosure has been proposed to solve these problems, and the present disclosure provides a vehicle seat and a control method thereof that induce the forward seating of a seated person and assist the standing of the seated person by controlling a tip-up actuating assembly, a tilting actuating assembly, and a support plate based on the distribution of body pressure acting on a seat cushion.

The technical subjects pursued in the present disclosure may not be limited to the above-mentioned technical subjects, and other technical subjects which are not mentioned may be clearly understood from the following descriptions by those skilled in the art to which the present disclosure pertains.

In view of the foregoing, according to an aspect of the present disclosure, a vehicle seat configured to assist standing of a seated person may include: a base; a cushion frame rotatably supported by the base; a tip-up actuating assembly configured to rotate the cushion frame with respect to the base; a cushion front frame rotatably supported at a first portion of the cushion frame; a cushion rear frame fixedly supported at a second portion of the cushion frame; a tilting actuating assembly configured to rotate a rear portion of the cushion front frame upward and forward with respect to the cushion frame; a seat cushion including a front cushion supported by the cushion front frame and a rear cushion supported by the cushion rear frame; a body pressure sensor configured to measure body pressure of the seated person acting on the front cushion and the rear cushion; a support plate rotatably disposed on the cushion rear frame; and a controller configured to control the tip-up actuating assembly, the tilting actuating assembly, and the support plate based on distributions of the body pressure acting on the front cushion and the rear cushion.

According to another aspect of the present disclosure, a method for controlling the vehicle seat may include: measuring, by the body pressure sensor, the body pressure acting on the front cushion and the rear cushion; and controlling, by the controller, the tip-up actuating assembly, the tilting actuating assembly, and the support plate based on the distribution of body pressure acting on the front cushion and the rear cushion to assist the standing of the seated person.

According to the vehicle seat of the present disclosure and the control method thereof, whether a seated person is ready to get off may be determined by measuring the distribution of body pressure acting on the front cushion and the rear cushion, thereby inducing the forward seating of the seated person and more effectively assisting the standing of the seated person.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a flowchart illustrating a control method of a vehicle seat according to an embodiment;

FIG. 2 is a view illustrating a vehicle seat according to an embodiment;

FIG. 3 is a view illustrating a base, a cushion frame, a controller, a body pressure sensor, an output device, and an input device according to an embodiment;

FIG. 4 is a view illustrating the base and the cushion frame of FIG. 3;

FIG. 5 is a view sequentially illustrating the operation of the vehicle seat according to an embodiment;

FIG. 6 is a top view of a cushion rear frame according to an embodiment;

FIG. 7 is a bottom view of the cushion rear frame according to an embodiment; and

FIG. 8 is a view illustrating the operation of a support plate according to an embodiment.

### DETAILED DESCRIPTION OF THE EXEMPLARY EMBODIMENTS

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are disposed only for the sake of easy understanding of the embodiments set forth herein, and the technical idea of the present disclosure is not limited to the accompanying drawings and includes all modifications, equivalents, or alternatives falling within the spirit and scope of the present disclosure. The following descriptions are not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to specific embodiments. However, as understood by a person ordinarily skilled in the art to which the present disclosure belongs, the various aspects disclosed herein may be modified or otherwise implemented in different ways without departing from the spirit and scope of the present disclosure. Accordingly, the following description is to be considered exemplary, and is intended to teach those ordinarily skilled in the art to which the disclosure belongs how to make and use various embodiments. It is to be understood that the forms of the disclosure illustrated and described herein are exemplary embodiments. Equivalent elements, materials, processes, or steps may be substituted for those exemplified and described in the present disclosure. Expressions used in the present disclosure, such as “including,” “comprising,” “incorporating,” “consisting of,” “having,” or “is,” should be interpreted in a non-exclusive manner, i.e., to allow for the inclusion of items, components, or elements not explicitly listed. In addition, references to the singular form should be interpreted to include the plural form as well.

Furthermore, the various embodiments disclosed herein should be regarded as exemplary and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method disclosed herein. Accordingly, references to joining should be interpreted broadly. Moreover, these references to joining do not imply that two or more elements are directly connected to each other. In addition, all numerical terms, such as “first,” “second,” “third,” “primary,” “secondary,” “main,” or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference.

These terms may be used to describe various elements, but the elements are not be limited by the terms. The above terms are used merely for the purpose of distinguishing one element from other elements.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

In addition, a unit or a control unit included in names is merely a term widely used for naming a controller configured to control a specific function of a vehicle, but does not mean a generic function unit.

In order to control functions in charge, a controller may include a communication device configured to communicate with a sensor or another controller, a memory configured to store an operating system or logic instructions and input/output information, and at least one processor configured to perform determination, calculation, decision or the like required for control of the functions in charge.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, embodiments set forth herein will be described in detail with reference to the accompanying drawings, and the same or similar elements are given the same and similar reference numerals regardless of figure numbers, so duplicate descriptions thereof will be omitted.

A vehicle seat allows an occupant to sit comfortably in the vehicle and use the vehicle.

For a normal passenger, there is no significant difficulty in sitting on the vehicle seat. However, when an elderly person with weak leg strength or a passenger with a lower limb disability sits on the vehicle seat, it may be difficult to cope with the abrupt posture changes required before and after seating.

When an elderly person with weak leg strength or a passenger with a lower limb disability boards a vehicle, a structure in which the seat moves out of the vehicle to accommodate the elderly person or the passenger has been widely used. However, this method requires a mechanism such as a robot to move the seat, which results in drawbacks such as increased weight and material costs.

Accordingly, there is a demand for a vehicle seat and a control method thereof that enhance the convenience of getting on and off by assisting the movements of an elderly person with weak leg strength or a passenger with a lower limb disability while reducing weight and material costs.

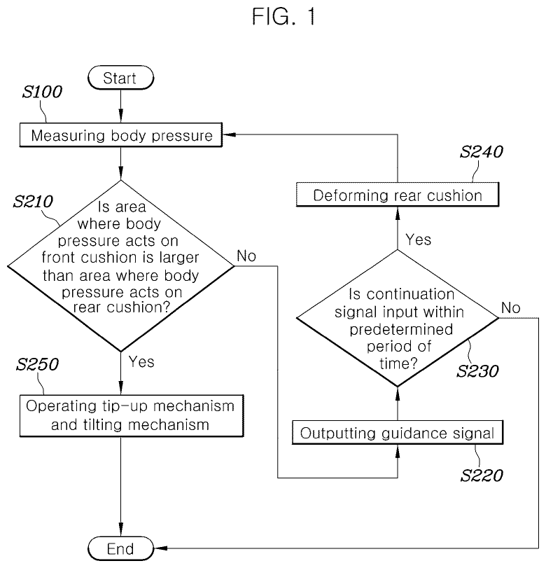

Referring to FIGS. 1 to 8, according to an embodiment, a vehicle seat configured to assist standing of a seated person includes: a base 1; a cushion frame 3 rotatably supported by the base 1; a tip-up actuating assembly 5 configured to rotate the cushion frame 3 with respect to the base 1; a cushion front frame 7 rotatably supported at a front portion of the cushion frame 3; a cushion rear frame 8 fixedly supported at a rear portion of the cushion frame 3; a tilting actuating assembly 9 configured to rotate the rear portion of the cushion front frame 7 upward and forward with respect to the cushion frame 3; a seat cushion 11 including a front cushion 15 supported by the cushion front frame 7 and a rear cushion 17 supported by the cushion rear frame 8; a body pressure sensor 45 configured to measure a body pressure of the seated person acting on the front cushion 15 covering the cushion front frame 7 and the rear cushion 17 covering the cushion rear frame 8; a support plate 33 rotatably installed on the cushion rear frame 8; and a controller 43 configured to control the tip-up actuating assembly 5, the tilting actuating assembly 9, and the support plate 33 based on a distribution of the body pressure acting on the front cushion 15 and the rear cushion 17.

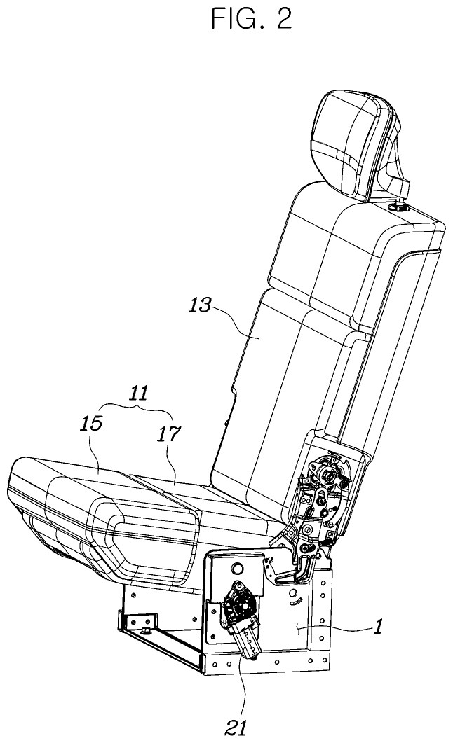

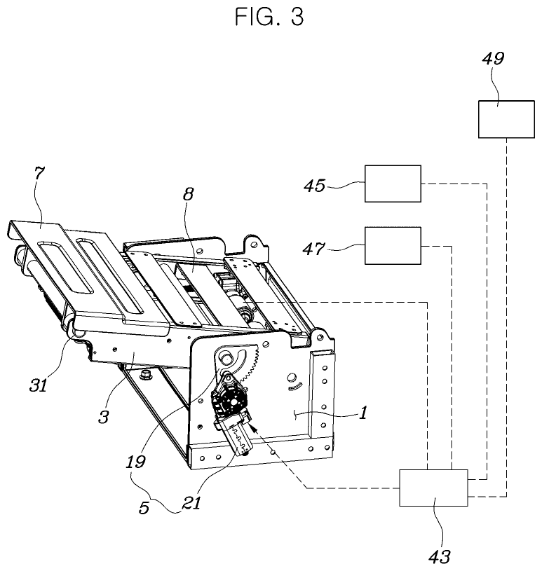

Referring to FIGS. 2 and 3, in an embodiment, the seat of the present disclosure may include the base 1 fixed to a vehicle body or the like, a seat cushion 11 installed on the base 1 to allow a passenger to be substantially seated, a seatback 13 that supports the back of the seated passenger, and so on. The seat cushion 11 may include the front cushion 15 supported by the cushion front frame 7 and the rear cushion 17 supported by the cushion rear frame 8. The cushion frame 3 may be rotated such that its front portion moves upward while tipping up with respect to the base 1. At this time, the cushion front frame 7 may be configured to rotate its rear portion upward with respect to the cushion frame 3 while continuously supporting the lower body of the seated person in a posture within a predetermined horizontal range.

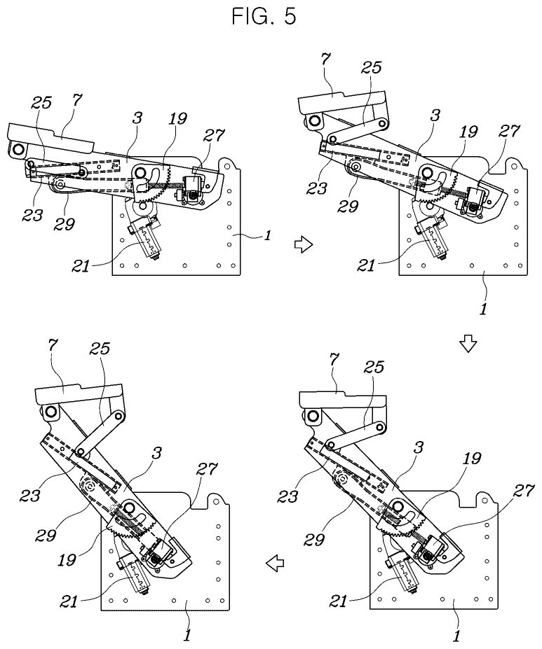

Accordingly, the vehicle seat of the present disclosure transitions from the initial seated state, as illustrated in FIG. 5, to the final standing state, lifting the lower body or hips of the seated person from the seated state to the standing state, thereby allowing, for example, an elderly person or a person with a disability to easily stand up from the seat. Conversely, by supporting the lower body or hips of a passenger intending to sit from the standing state and gradually transitioning to the seated state, the vehicle seat may assist, for example, an elderly person or a person with a disability, in easily sitting on the seat.

In an embodiment, the controller 43 may be configured for controlling the tip-up actuating assembly, the tilting actuating assembly, and the support plate based on the distribution of body pressure acting on the front cushion and the rear cushion.

Referring to FIG. 3, the tip-up actuating assembly 5 may include a sector gear 19 integrally disposed on the cushion frame 3 and a tip-up motor 21 fixed to the base 1 to rotate the sector gear 19.

Specifically, when the controller 43 controls the tip-up motor 21 to operate, the sector gear 19 is rotated with respect to the base 1, thereby ultimately causing the cushion frame 3 to rotate with respect to the base 1 and to transition from the seated state to the standing state, as illustrated in FIG. 5.

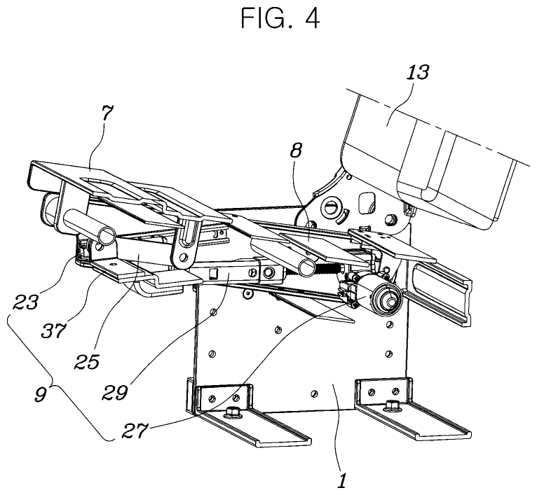

Referring to FIG. 4, the tilting actuating assembly 9 may include a slider 23 disposed to be capable of linear sliding in the front-rear direction with respect to the cushion frame 3, a tilting link 25 connecting the slider 23 and the cushion front frame 7 such that when the slider 23 slides rearward, the rear portion of the cushion front frame 7 rotates upward and forward with respect to the cushion frame 3, a tilting motor 27 disposed on the cushion frame 3, and a tilting guide 29 configured to convert the rotational displacement of the tilting motor 27 into linear displacement and to provide it to the slider 23.

Specifically, when the controller 43 controls the tilting motor 27 to operate, the tilting guide 29 converts the rotational displacement of the tilting motor 27 into linear displacement and provides it to the slider 23. The slider 23 then slides linearly with respect to the cushion frame 3, thereby rotating the cushion front frame 7 via the tilting link 25.

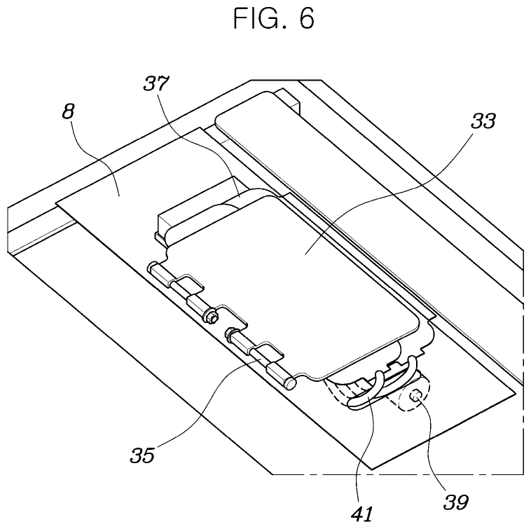

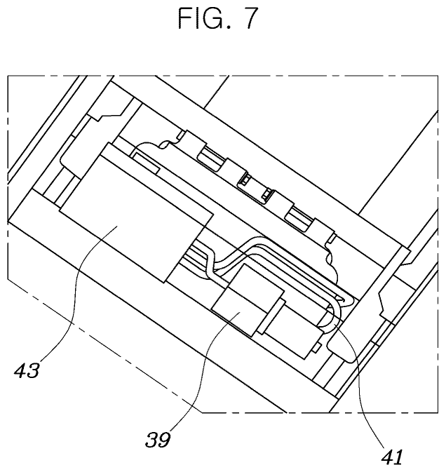

Referring to FIGS. 6 and 7, the vehicle seat of the present disclosure may include the cushion rear frame 8, the rear cushion 17 supported by the cushion rear frame 8, a support plate 33 coupled to the cushion rear frame 8 via a support plate hinge 35, one or more air cells 37 disposed below the support plate 33, an air pump 39 configured to introduce or discharge air into or from the air cells 37, an air hose 41 connecting the air cells 37 and the air pump 39, and a controller 43.

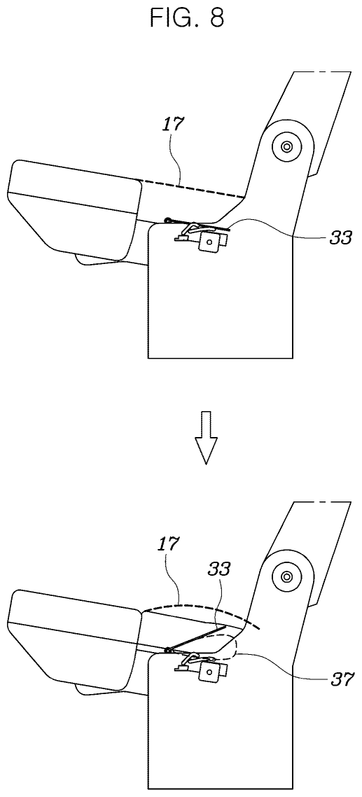

Referring to FIG. 8, when the controller 43 controls the air pump 39 to operate, air may be introduced into or discharged from the air cells 37 through the air hose 41 by the air pump 39 so that the volume of the air cells 37 is changed, thereby rotating the support plate 33 about the support plate hinge 35. When the support plate 33 rotates, the rear cushion 17 may be deformed, and the seated person may recognize the deformed rear cushion 17 as illustrated in FIG. 8, and may correct his/her posture to the front cushion 15.

In an embodiment, as illustrated in FIG. 3, a body pressure sensor 45, an output device 47, and an input device 49 may be disposed in the vehicle seat of the present disclosure and connected to the controller 43.

In an embodiment, the body pressure sensor 45 may measure the body pressure of the seated person acting on the seat cushion 11 and transmit the measurement to the controller 43.

For example, the body pressure sensor 45 may be a sensor configured for measuring the intensity or distribution of the body pressure of the seated person, such as a resistive film sensor, a piezoelectric sensor, a capacitive sensor, or a fiber optic sensor, but is not limited to these examples.

For example, the body pressure sensor 45 may be disposed on the front cushion 15 and the rear cushion 17 of the seat cushion 11 and may measure the distribution of body pressure acting on the seat cushion 11, including the front cushion 15 and the rear cushion 17.

For example, the body pressure sensor 45 may measure the area over which body pressure is distributed on the front cushion 15 and the area over which body pressure is distributed on the rear cushion 17. The body pressure sensor 45 may transmit the body pressure measurement information to the controller 43.

For example, based on the body pressure measurement information received from the body pressure sensor 45, the controller 43 may be configured to determine and compare the widths or ratio of the area where body pressure is distributed on the front cushion 15 and the area where body pressure is applied on the rear cushion 17.

For example, based on the body pressure measurement results received from the body pressure sensor 45, the controller 43 may be configured to determine that the area where body pressure is distributed on the front cushion 15 is 70 cm², while the area where body pressure is distributed on the rear cushion 17 is 30 cm². For example, the controller 43 may be configured to determine that the area where body pressure is distributed on the front cushion 15 is larger than that on the rear cushion 17. However, these examples are for illustrative purposes only and are not limited to the above numerical values.

In an embodiment, the output device 47 may receive a guidance signal from the controller 43 that induces the forward seating of the seated person and output the signal to the seated person.

For example, the output device 47 may be a device configured for outputting a guidance signal to the seated person, such as a speaker, a display device, or a vibration device, but is not limited to these examples.

More specifically, the input device 49 may receive a start signal requesting the initiation of standing assistance for a seated person or a continuation signal requesting the continuation of standing assistance, and may transmit the received signal to the controller 43.

The input device 49 may be a device configured for receiving a start signal or a continuation signal for standing assistance from the seated person and transmitting the signal to the controller 43, such as a button, a keyboard, a touchscreen, a microphone, or a camera. For example, the seated person may press the input device 49, which is configured as a button, to input a start signal or a continuation signal for standing assistance to the controller 43.

Hereinafter, referring to FIG. 1, the standing assistance operation process of the vehicle seat of the present disclosure will be specifically described.

When a start signal requesting the initiation of standing assistance is input to the controller 43, the body pressure sensor 45 may measure the body pressure acting on the front cushion 15 and the rear cushion 17 of the seat cushion 11 (S100).

More specifically, when the controller 43 receives a start signal for standing assistance from the seated person via the input device 49, the controller 43 may be configured for controlling the body pressure sensor 45 so that the body pressure sensor 45 measures the area where body pressure is distributed on the front cushion 15 and the area where body pressure is distributed on the rear cushion 17, and the controller 43 may receive this measurement from the body pressure sensor 45.

Subsequently, based on the body pressure measured on the front cushion 15 and the body pressure measured on the rear cushion 17, the controller 43 may be configured for controlling the tip-up actuating assembly 5, the tilting actuating assembly 9, and the support plate 33 to assist the standing of the seated person (S200).

More specifically, the controller 43 may be configured to determine whether the area where body pressure is distributed on the rear cushion 17 is larger than the area where body pressure is distributed on the front cushion 15 (S210).

When the area where body pressure is distributed on the front cushion 15 is smaller than the area where body pressure is distributed on the rear cushion 17, the controller 43 may output a guidance signal inducing the forward seating of the seated person without operating the tip-up actuating assembly 5 and the tilting actuating assembly 9 (S220).

The controller 43 may be configured for controlling the output device 47 so that the guidance signal is output to the seated person. The controller 43 may be configured to determine whether a continuation signal requesting the continuation of standing assistance is input to the controller 43 within a predetermined interval after the guidance signal is output (S230).

When the continuation signal is not input within the predetermined interval after the guidance signal is output, the tip-up actuating assembly 5 and the tilting actuating assembly 9 may not be operated. More specifically, the controller 43 may be configured for controlling the system so that the tip-up actuating assembly 5 and the tilting actuating assembly 9 are not operated when the continuation signal is not input within the predetermined interval after the guidance signal is output.

When the continuation signal is input within the predetermined interval after the guidance signal is output, the rear cushion may be deformed to induce the forward seating of the seated person (S240).

More specifically, when the continuation signal is input within the predetermined interval after the guidance signal is output, the controller 43 may be configured for controlling the air pump 39, which will be described later, so that the rear cushion is deformed. For example, when the continuation signal is input to the controller 43 via the input device 49 within the predetermined interval after the guidance signal is output, the controller 43 may be configured for controlling the air pump 39 to introduce or discharge air into or from the air cells 37, thereby changing the volume of the air cells 37. As a result, the air cells 37 positioned below the support plate 33 may change in volume, causing the support plate 33 to rotate about the support plate hinge 35. Consequently, as illustrated in FIG. 8, the rear cushion 17 may be deformed, thereby inducing the forward seating of the seated person.

On the other hand, when an area where the body pressure is distributed on the front cushion is larger than an area where the body pressure is distributed on the rear cushion, the controller 43 may be configured for controlling the tip-up actuating assembly 5 and the tilting actuating assembly 9 to operate, thereby rotating the seat cushion 11 and the front cushion 15 (S250).

Through the above process, the vehicle seat of the present disclosure may induce the forward seating of the seated person based on body pressure and may assist the standing of the seated person.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A vehicle seat configured to assist standing of a seated person, the vehicle seat comprising:
a base;
a cushion frame rotatably supported by the base;
a tip-up actuating assembly configured to rotate the cushion frame with respect to the base;
a cushion front frame rotatably supported at a first portion of the cushion frame;
a cushion rear frame fixedly supported at a second portion of the cushion frame;
a tilting actuating assembly configured to rotate a rear portion of the cushion front frame upward and forward with respect to the cushion frame;
a seat cushion comprising a front cushion supported by the cushion front frame and a rear cushion supported by the cushion rear frame;
a body pressure sensor configured for measuring body pressure of the seated person acting on the front cushion and the rear cushion;
a support plate rotatably disposed on the cushion rear frame; and
a controller electrically connected to the body pressure sensor and configured to control the tip-up actuating assembly, the tilting actuating assembly, and the support plate based on distributions of the body pressure acting on the front cushion and the rear cushion.

2. The vehicle seat of claim 1, wherein the body pressure sensor is configured for measuring the body pressure acting on the front cushion and the rear cushion based on that a start signal for standing assistance is input to the controller.

3. The vehicle seat of claim 2, wherein the tip-up actuating assembly and the tilting actuating assembly are operated based on that an area where the body pressure is distributed on the front cushion is larger than an area where the body pressure is distributed on the rear cushion.

4. The vehicle seat of claim 2, wherein the controller is further configured to output a guidance signal inducing forward seating of the seated person based on that the area where body pressure is distributed on the front cushion is smaller than the area where body pressure is distributed on the rear cushion.

5. The vehicle seat of claim 4, wherein the support plate is configured to rotate to deform the rear cushion based on that a continuation signal is input to the controller within a predetermined interval after the guidance signal is output.

6. The vehicle seat of claim 1, further comprising:
air cells disposed below the support plate;
an air pump connected to the controller and configured to introduce or discharge air into or from the air cells, to rotate the support plate about a support plate hinge of the support plate.

7. The vehicle seat of claim 6, wherein the controller is configured to control the air pump to change the volume of the air cells in response to inflow and outflow of air in the air cells,
wherein the support plate is configured to rotate in response to the volume change of the air cells.

8. The vehicle seat of claim 1, wherein the tip-up actuating assembly includes:
a sector gear integrally disposed on the cushion frame; and
a tip-up motor fixed to the base and engaged to the sector gear to rotate the sector gear.

9. The vehicle seat of claim 1, wherein the tilting actuating assembly includes:
a slider linearly-sliding in a front-rear direction with respect to the cushion frame;
a tilting link connecting the slider and the cushion front frame so that when the slider slides rearward, the rear portion of the cushion front frame rotates upward and forward with respect to the cushion frame;
a tilting motor disposed on the cushion frame; and
a tilting guide engaged to the tilting motor.

10. The vehicle seat of claim 9, wherein based on that the controller controls the tilting motor to operate, the tilting guide converts the rotational displacement of the tilting motor into the linear displacement so that the slider slides linearly with respect to the cushion frame, thereby rotating the cushion front frame via the tilting link.

11. A method for controlling the vehicle seat of claim 1, the method comprising:
measuring, by the body pressure sensor, the body pressure acting on the front cushion and the rear cushion; and
controlling, by the controller, the tip-up actuating assembly, the tilting actuating assembly, and the support plate based on the distribution of the body pressure acting on the front cushion and the rear cushion to assist the standing of the seated person.

12. The method of claim 11, wherein the measuring of the body pressure acting on the front cushion and the rear cushion comprises:
measuring the body pressure acting on the front cushion and the rear cushion based on that a start signal for standing assistance is input to the controller.

13. The method of claim 12, wherein the assisting of the standing of the seated person comprises:
operating, by the controller, the tip-up actuating assembly and the tilting actuating assembly based on that an area where the body pressure is distributed on the front cushion is larger than an area where the body pressure is distributed on the rear cushion.

14. The method of claim 13, wherein the assisting of the standing of the seated person further comprises:
outputting, by the controller, a guidance signal inducing forward seating of the seated person based on that the area where body pressure is distributed on the front cushion is smaller than the area where body pressure is distributed on the rear cushion.

15. The method of claim 14, wherein the assisting of the standing of the seated person comprises:
inducing, by the controller, the forward seating of the seated person by deforming the rear cushion based on that a continuation signal is input within predetermined interval after the guidance signal is output.

16. The method of claim 12, wherein the assisting of the standing of the seated person comprises:
outputting, by the controller, a guidance signal inducing forward seating of the seated person based on that an area where the body pressure is distributed on the front cushion is smaller than an area where the body pressure is distributed on the rear cushion.

17. The method of claim 16, wherein the assisting of the standing of the seated person comprises:
inducing, by the controller, the forward seating of the seated person by deforming the rear cushion based on that a continuation signal is input within predetermined interval after the guidance signal is output.

18. The method of claim 17,
wherein the inducing of the forward seating of the seated person comprises injecting air into air cells to rotate the support plate, the air cells disposed below the support plate and configured to change in volume in response to inflow and outflow of air.
